(19) United States
(12) Patent Application Publication
(10) Pub. No.: US 2026/0230887 A1
(43) Pub. Date: Aug. 6, 2026

(54) ENHANCED MDT MEASUREMENT IN MIXED NETWORK DEPLOYMENT

(71) Applicant: QUALCOMM Incorporated, San Diego, CA (US)

(72) Inventors: Hargovind Prasad BANSAL, Bharatpur, Rajasthan (IN); Tom CHIN, San Diego, CA (US); Akash KUMAR, Hyderabad, Telangana (IN)

(21) Appl. No.: 19/153,319

(22) PCT Filed: May 15, 2023
(86) PCT No.: PCT/US2023/067011

§ 371 Date: Aug. 1, 2025

(30) Foreign Application Priority Data
Mar. 27, 2023 (IN) 202341021918

(51) Int. Cl. H04W 24/10; H04W 16/18; H04W 84/06; H04W 84/18

(52) U.S. Cl. CPC H04W 24/10; H04W 16/18; H04W 84/06; H04W 84/18

(57) ABSTRACT

This disclosure provides methods, components, devices and systems for MDT measurement and reporting in mixed network deployments. Some aspects specifically relate to optimizing logged MDT measurements in network deployments including NTN cells and TN cells. In some examples, a UE receives, from a network entity, a logged measurement configuration which indicates whether the UE is configured to limit its MDT measurements to NTN cells or TN cells during an MDT session, or whether the UE is not limited and may report measurements for both NTN and TN cells. In some examples, the logged measurement configuration may further indicate, when the UE is not limited in its MDT measurements, whether the NTN cells or the TN cells are prioritized for MDT measurement and reporting. The prioritization may be based on a UE state or capability. In further examples, these aspects may be extended to other network deployments including SONs and SBAs.

### CROSS REFERENCE TO RELATED APPLICATION(S)

This application claims the benefit of Indian Patent Application Serial No. 202341021918, filed on Mar. 27, 2023, entitled “ENHANCED MDT MEASUREMENT IN MIXED NETWORK DEPLOYMENT” which is incorporated herein by reference in its entirety.

### BACKGROUND

### Technical Field

The present disclosure generally relates to wireless communication, and more particularly, to a wireless communication system providing minimization of drive test (MDT) measurement and reporting in mixed network deployments.

### Description of the Related Technology

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure can be implemented in a method for wireless communication performable at a user equipment (UE). The method includes receiving, from a network entity, a logged measurement configuration indicating whether the UE is to report minimization of drive test (MDT) measurements associated with a network deployment, and transmitting an MDT report to the network entity including the MDT measurements according to the logged measurement configuration.

Another innovative aspect of the subject matter described in this disclosure can be implemented in an apparatus for wireless communication, such as a UE. The apparatus includes a memory, and a processor communicatively coupled with the memory. The processor is operable to cause the apparatus to receive, from a network entity, a logged measurement configuration indicating whether the apparatus is to report MDT measurements associated with a network deployment, and transmit an MDT report to the network entity including the MDT measurements according to the logged measurement configuration.

In some examples of the methods and apparatuses, the logged measurement configuration indicates the UE to report the MDT measurements for a selected type of cells associated with the network deployment.

In some examples of the methods and apparatuses, the logged measurement configuration indicates the UE to optionally report the MDT measurements for a prioritized type of cells associated with the network deployment.

Another innovative aspect of the subject matter described in this disclosure can be implemented in a method for wireless communication performable at a network entity. The method includes transmitting, to a UE, a logged measurement configuration indicating whether the UE is to report MDT measurements associated with a network deployment, and receiving an MDT report from the UE including the MDT measurements according to the logged measurement configuration.

Another innovative aspect of the subject matter described in this disclosure can be implemented in an apparatus for wireless communication, such as a network entity. The apparatus includes a memory and a processor communicatively coupled with the memory. The processor is operable to cause the apparatus to transmit, to a UE, a logged measurement configuration indicating whether the UE is to report MDT measurements associated with a network deployment, and receive an MDT report from the UE including the MDT measurements according to the logged measurement configuration.

In some examples of the methods and apparatuses, the logged measurement configuration indicates the UE to report the MDT measurements for a selected type of cells associated with the network deployment.

In some examples of the methods and apparatuses, the logged measurement configuration indicates the UE to optionally report the MDT measurements for a prioritized type of cells associated with the network deployment.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first subframe within a 5G NR frame structure.

FIG. 2B is a diagram illustrating an example of DL channels within a 5G NR subframe.

FIG. 2C is a diagram illustrating an example of a second subframe within a 5G NR frame structure.

FIG. 2D is a diagram illustrating an example of UL channels within a 5G NR subframe.

FIG. 3 is a block diagram of a base station (BS) in communication with a UE in an access network.

FIG. 4 illustrates an example of a call flow between a UE and a BS during a logged minimization of drive test (MDT) measurement and reporting process.

FIG. 5 is a diagram illustrating an example of an enhanced logged measurement configuration.

FIG. 6 is a diagram illustrating another example of an enhanced logged measurement configuration.

FIG. 7 is a flowchart of a method of wireless communication at a UE.

FIG. 8 is a flowchart of a method of wireless communication at a network entity such as a base station.

FIG. 9 is a diagram illustrating an example of a hardware implementation for a UE apparatus.

FIG. 10 is a diagram illustrating an example of a hardware implementation for a BS apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects generally relate to minimization of drive test (MDT) measurement and reporting in mixed network deployments, or network deployments involving multiple architectural types, infrastructures, network functions, operators, services, or a combination of any of the foregoing. More particularly, aspects specifically relate to optimizing logged MDT measurements in network deployments including non-terrestrial network (NTN) cells and terrestrial network (TN) cells. In one example, a user equipment (UE) may receive, from a base station, a logged measurement configuration including a parameter which limits MDT measurement and reporting to a selected type of cell indicated in the configuration. In particular, the logged measurement configuration may include a logged measurement type parameter which indicates whether the UE is configured to limit its MDT measurements to NTN cells during an MDT session, whether the UE is configured to limit its MDT measurements to TN cells during the MDT session, or whether the UE is not limited in its MDT measurements and may report measurement results for both NTN cells and TN cells. In another example, the logged measurement configuration may further include a parameter which indicates the UE to prioritize MDT measurement and reporting for a prioritized type of cell indicated in the configuration. In particular, the logged measurement configuration may further include a logged measurement priority parameter which indicates, in the case where the UE is not limited in its MDT measurements and may report measurement results for both NTN cells and TN cells, whether the NTN cells or the TN cells are prioritized for MDT measurement and reporting. The prioritization may be based on a UE state or capability. For example, if the UE is in a state of having too low battery power, a state of high thermal activity, or another state which prevents or otherwise impacts the UE from performing MDT data collection in a complete set of NTN and TN cells within the time period of the MDT session, the UE may determine to collect and report MDT measurement results for either NTN cells or TN cells (whichever is the indicated prioritized type of cells) but not both types of cells. In further examples, these aspects may be extended to other mixed network deployments including the UE and base station, such as self-organizing networks (SONs) and service-based architectures (SBAs).

Particular aspects of the subject matter described in this disclosure can be implemented to realize one or more of the following potential advantages. By enhancing logged MDT configurations through inclusion of the logged measurement type parameter in the logged MDT configuration, UE power and battery life may be saved, and the total number of bytes that the UE may transfer over the air in MDT reports may be significantly reduced. For example, if the base station configures the logged measurement type parameter to limit MDT measurements and reporting to either NTN cells or TN cells, the amount of segmented MDT reports which the UE sends to the base station in response to the configuration may be reduced, and in some cases, segmentation may be avoided altogether. Similarly, the amount of data the UE sends in a single MDT report (even if no segmentation occurs) may be reduced, and UE power may thus be conserved, as a result of this configuration. On the other hand, if the UE is configured via the logged measurement type parameter to measure and report MDT data for both NTN cells and TN cells, but the UE is in a low power state or otherwise unable to fully perform MDT data collection of both types of cells, the base station may configure the UE to prioritize one type of cell over the other via the logged measurement priority parameter, thereby providing a balance between network and operator interest with UE capability for MDT measurement and reporting. Furthermore, by configuring the UE to prioritize one type of cell over another for MDT measurement and reporting, MDT session shutdowns due to low battery or power states may be minimized or avoided. Additionally, since configuration of these parameters may be extended beyond the context of NTNs and TNs to SONs, SBAs, or other mixed network deployments, SONs and SBAs may be optimized, and improved support for MDT measurement and reporting in mixed network deployments may be achieved.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

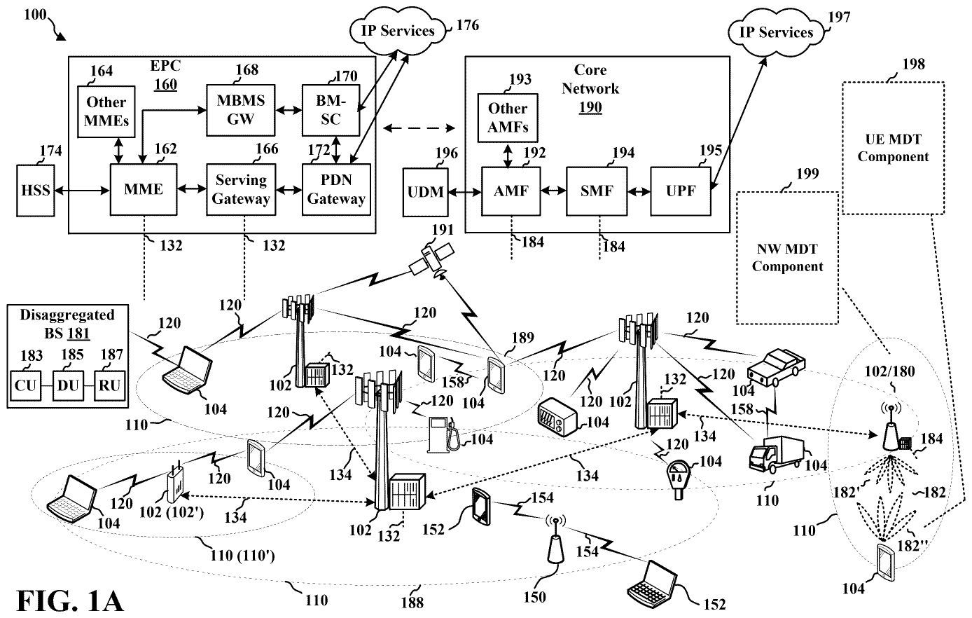

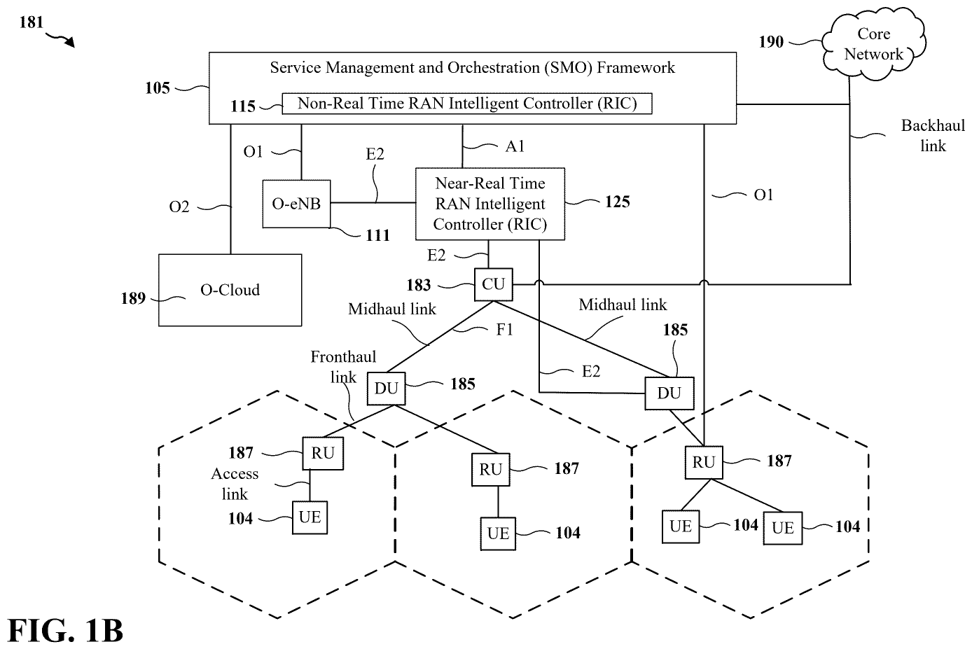

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR 1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR 1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1B shows a diagram illustrating an example disaggregated base station 181 architecture. The disaggregated base station 181 architecture may include one or more CUs 183 that can communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUS 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 can be logically split into one or more CU-UP units and one or more CU-CP units. The CU-UP unit can communicate bidirectionally with the CU-CP unit via an interface, such as the El interface when implemented in an O-RAN configuration. The CU 183 can be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 185 may further host one or more low PHY layers. Each layer (or module) can be implemented with an interface configured to communicate signals with other layers (and modules) hosted by the DU 185, or with the control functions hosted by the CU 183.

Lower-layer functionality can be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 can be implemented to handle over the air (OTA) communication with one or more UEs 104. In some implementations, real-time and non-real-time aspects of control and user plane communication with the RU(s) 187 can be controlled by the corresponding DU 185. In some scenarios, this configuration can enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements can include, but are not limited to, CUs 183, DUs 185, RUs 187 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 187 via an Ol interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

Referring again to FIG. 1A, in certain aspects, the UE 104 may include a UE MDT component 198 that is configured to receive, from a network entity such as base station 102/180, a logged measurement configuration indicating whether the UE is to report MDT measurements associated with a network deployment, such as a mixed network deployment, and transmit an MDT report to the network entity including the MDT measurements according to the logged measurement configuration.

In certain aspects, the base station 102/180 (or other network entity with base station functionality) may include a NW MDT component 199 that is configured to transmit, to a UE such as UE 104, a logged measurement configuration indicating whether the UE is to report MDT measurements associated with a network deployment, such as a mixed network deployment, and receive an MDT report from the UE including the MDT measurements according to the logged measurement configuration.

As referenced throughout this disclosure, a mixed network deployment is a network deployment, such as the wireless communications system and access network 100 in FIG. 1A, which involves multiple architectural types, multiple infrastructures, multiple network functions, multiple services, multiple operators, or a combination of any of the foregoing. For example, a network deployment including a non-terrestrial network (NTN) and a terrestrial network (TN) may be considered a mixed network deployment, since NTNs and TNs have at least different types of architectures or infrastructures. Similarly, a network deployment including a self-organizing network (SON), and a network deployment including a service-based architecture (SBA), may respectively be considered mixed network deployments, since SONs may have at least multiple network functions and SBAs may have at least multiple services.

An NTN is a network involving non-terrestrial flying objects, and may include, but is not limited to, a satellite communication network, a high-altitude platform system (HAPS), or an air-to-ground network, among other networks. Similarly, an NTN cell is a cell which may be served by a spaceborne platform such as a low Earth orbiting (LEO) satellite, a medium Earth orbiting (MEO) satellite, or a geosynchronous Earth orbiting (GEO) satellite, an airborne platform such as an airplane, balloon, airship, or International Mobile Telecommunications base station (HIBS), a ground station having antennas up-tilted towards the sky for providing in-flight connectivity for airplanes, a mobile enabled, low-altitude, unmanned aerial vehicle (UAV) or drone, or other base station or network entity providing NTN connectivity. In contrast, a TN is a network that does not involve satellites or other such non-terrestrial flying objects, and a TN cell is a cell which may be served by a ground station or other network entity that provides terrestrial coverage to UEs. For instance, in the example wireless communications system and access network 100 of FIG. 1A, both a TN and a NTN may be provided, where at least one of the coverage areas 110 or cells may be a TN cell 188 in which base station 102/180 provides terrestrial coverage to UEs 104 (without a satellite intermediary), and at least one other coverage area 110 or cell may be an NTN cell 189 in which base station 102/180 provides non-terrestrial coverage to UEs 104 via satellite 191.

While the aforementioned distinctions between NTNs and TNs are generally understood, for purposes of the present disclosure, a mixed network deployment that includes NTN cells 189 and TN cells 188 is not limited to these concepts, since NTNs and TNs may be interpreted in a broader manner. For example, an NTN may alternatively be understood to include cells served by base station 102/180 or other network entity which is located farther from the ground, while a TN may be understood to include cells served by a base station or other network entity which is located closer to the ground. Thus, a network that includes coverage areas 110 or cells served by GEOs or MEOs may still be categorized as an NTN, but a network that includes coverage areas 110 or cells served by LEOs may in this case be categorized as a TN (rather than an NTN based on this broader interpretation). Similarly, a network that includes coverage areas 110 or cells having base stations 102/180 located above the ground may be categorized as an NTN, while a network that includes coverage areas 110 or cells having base stations 102/180 located on the ground may be categorized as a TN even if these cells are served by ground stations including up-tilted antennas.

Furthermore, while the aspects of the present disclosure specifically refer to mixed network deployments including NTN cells 189 and TN cells 188, the concepts and various aspects described herein may similarly apply to other network deployments involving a mixture of different functions or services, such as SONs or SBAs. For example, in 5G/NR, a centralized SON may interact with different network functions to implement SON functions such as monitoring, analysis, decision, execution and evaluation of a network, and a SBA may implement different network functions (such as the AMF 192, SMF 194, UPF 195, and the like) as software-defined services in a cloud native environment. There are also plans in 6G and beyond for an SBA to provide a cloud-based service delivery platform in which network functions may be implemented not only in central cloud sites but also may be extended to regional cloud sites, edge cloud sites, and radio sites with different processing and service capabilities.

Thus, although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

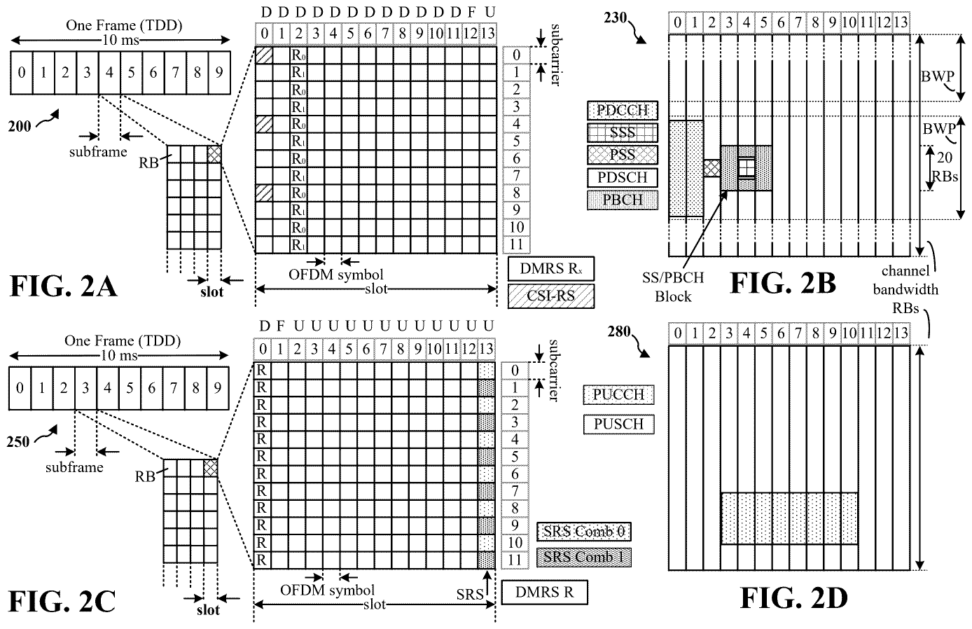

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology u=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK) / non-acknowledgement (NACK) feedback. The PUSCH carries data and may additionally be used to carry a buffer status report (BSR), a power headroom report (PHR), and/or UCI.

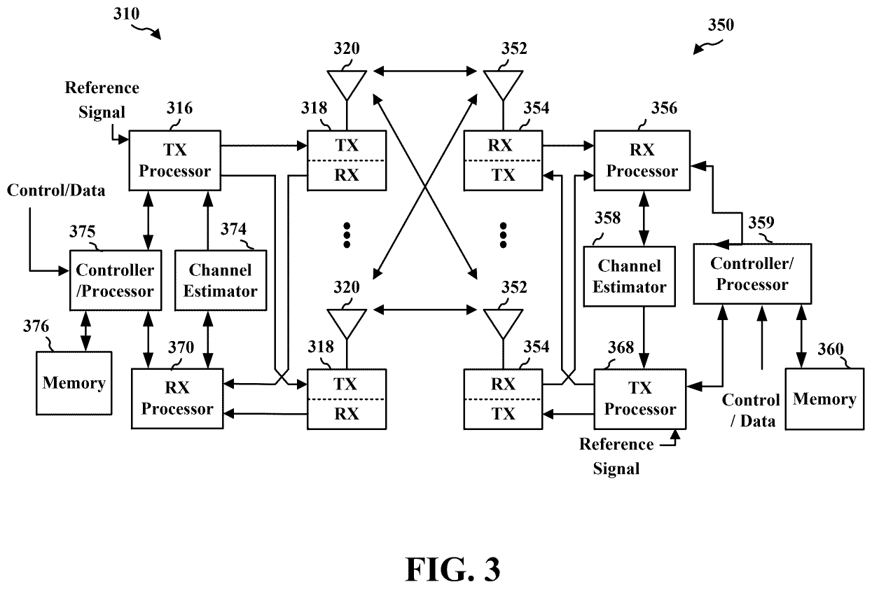

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with UE MDT component 198 of FIG. 1A.

At least one of the TX processor 316, the RX processor 370, and the controller/processor 375 may be configured to perform aspects in connection with NW MDT component 199 of FIG. 1A.

To optimize mixed network deployments such as those involving NTNs and TNs, SONs, and SBAs, a minimization of drive test (MDT) measurement and reporting process may be applied. In MDT, UEs 104, 350 may be configured to serve as testing vehicles which measure network performance or UE performance, for example, while driving along a given route. For example, a UE 104, 350 may measure and report DL signal quantities measurement results for a serving cell and for intra-frequency/inter-frequency/inter-RAT neighbor cells, power headroom measurements, PDCP SDU data volume measurements separately for DL and UL, average UE throughput measurements separately for DL and UL, packet delay measurements, packet loss rate measurements, received signal strength indicator (RSSI) measurements for WLAN and Bluetooth®, round trip time (RTT) measurement for WLAN, or any combination of the foregoing. In response to receiving an MDT report including a log of these collected radio measurements from the UE 104, 350, the base station 102/180, 310 or other network entity may save the log to a trace record for use in network optimization. For instance, in the case of a mixed network deployment including NTN cells 189 and TN cells 188, the base station 102/180, 310 may filter MDT measurement data into separate trace files respectively for NTNs and TNs and transport or record these trace files to different network elements or nodes of EPC 160 or core network 190. Similarly for SBAs and SONs, the trace files may be filtered, transported, or recorded to different network functions for different services, such as to a centralized SON function to perform centralized capacity and coverage optimization. As a result, through MDT, network operators may minimize capital and operating expenditures in network optimization.

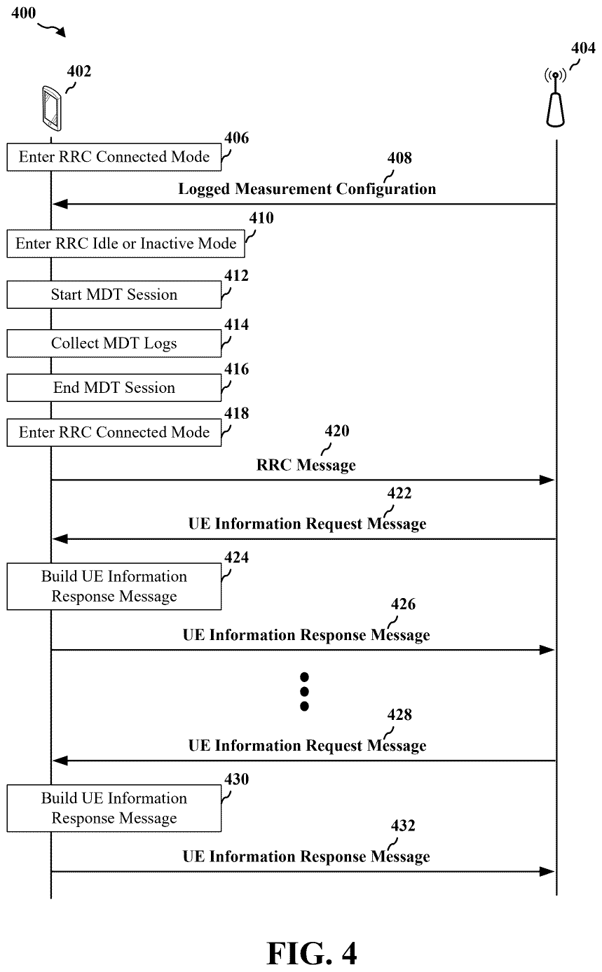

FIG. 4 illustrates an example 400 of a call flow between a UE 402 and a base station 404 which perform a logged MDT procedure. UE 402 may correspond to UE 104, 350, and base station 404 may correspond to base station 102/180, 181, 310. Initially, the base station 404 may receive an initial context setup request message (not shown) from a core network element, such as the AMF 192, which indicates UE capability information (including logged MDT support capability information), a PLMN list or other information related to the UE 402 performing MDT. After the UE 402 enters an RRC connected mode at block 406, the base station 404 may provide a logged measurement configuration 408 to the UE 402. This MDT configuration may include various parameters such as a job type indicating the UE 402 to perform logged MDT reporting, an area scope parameter indicating the cells where the MDT data collection is to take place and supporting the PLMNs in the PLMN list, the list of measurements the UE 402 is to perform, the logging interval defining the periodicity for logging MDT measurement results, the logging duration determining the validity of the MDT logged configuration beginning at a time of UE 402 reception of the configuration, and other general MDT configuration parameters. Some of these parameters may alternatively be omitted from the logged measurement configuration 408.

After receiving the logged measurement configuration 408, and after the UE 402 enters an RRC idle or inactive mode at block 410, the UE 402 may start an MDT session at block 412, which may be either UE-specific or area-specific. During the MDT session, at block 414, the UE may perform logging of available information or measurements as per the logged measurement configuration 408. The UE 402 may continue to collect MDT measurements at block 414 until either the duration timer indicated in the logging duration of the logged measurement configuration 408 has expired, or until UE memory reserved for MDT is full (in which case the UE stops logging and starts a 48-hour timer). At this point the UE 402 ends the MDT session at block 416. After the UE 402 again enters the RRC connected mode at block 418 (for example during connection establishment, handover, or re-establishment), the UE 402 sends an RRC message 420 to the base station 404 indicating the availability of its logged MDT measurements, such as an RRC connection setup complete, RRC setup complete, RRC connection resume complete, or RRC resume complete message indicating a logged measurement availability bit or flag.

The UE 402 may keep the MDT measurements stored in its memory (such as memory 360) until either the 48-hour timer expires, or until the base station 404 sends the UE 402 an RRC message requesting to retrieve the UE's report, such as a UE information request message 422 requesting the UE's collected measurement logs. In response to the request, the UE 402 may build its UE information response message at block 424 up to a predetermined size of MDT logs (such as 8 KB of MDT data), after which the UE may send a UE information response message 426 including its MDT logs to the base station. If the total UE log or amount of MDT data is too large for a single report (due to including measurement results amounting to more than 8 KB or other predetermined size), the UE may indicate the reported data is a segment via a data availability indicator in the UE information response message 426, and the base station 404 may again request to retrieve subsequent segment(s) from the UE 402 via a subsequent UE information request message 428. The UE 402 may subsequently build its next, UE information response message at block 430 respectively including up to another segment of 8 KB or other predetermined size of MDT measurements, and the UE 402 may send this next segment in a subsequent UE information response message 432 to the base station 404. This process may repeat where the base station 404 continues to send subsequent UE information request messages and the UE 402 continues to send subsequent UE information response messages, based on a first-in-first-out (FIFO) order of stored measurement entries for respective segments, until the total UE log has been reported. After receiving the final UE information response message or segment, the base station 404 may record the trace files including the saved UE logs for network optimization purposes.

Generally, when the UE 402 collects MDT logged measurement results during an MDT session at block 414, the amount of data the UE 402 collects may be significantly larger than the size of a single MDT report. For example, the total UE log may range in size from as low as 64 KB to as large as a few MB in size, even though this total RRC message size may be restricted in lower layers of the UE to 8 KB chunks. As a result, the UE 402 may end up sending to the base station 404 a large amount of segmented MDT reports via UE information response messages 426, 432 respectively in response to various, UE information request messages 422, 428. In cases where the UE 402 has limited memory, the UE 402 may not even be able to perform a full quantity of measurement results within the configured logging duration before UE memory reserved for MDT is full, and therefore some results may also end up not being measured or otherwise lost for MDT reporting.

While this segmentation and risk of lost measurements may be manageable in a single network deployment, for example, a network including only TN cells 188, the amount of MDT data the UE 402 may end up measuring, storing, and reporting for an MDT session during the process illustrated in FIG. 4 may be significantly increased in mixed network deployments. For example in a network deployment including NTN cells 189 and TN cells 188, the UE 402 may be triggered to measure and report MDT measurements for significantly more cells than in a network deployment solely having a TN, which further increases the amount of segmentation, the risk of lost measurements, and the UE's power consumption or battery usage that may be associated with MDT measurement and reporting. Such increases may result since the UE 402 is triggered to measure and report more bytes of MDT data via greater quantities of UE information response messages 426, 432, and since the UE 402 still has the same limited memory capacity despite the greater quantities of bytes being measured and reported. Moreover on the network side, additional filtering, recording, or transporting may occur at base station 404 for network optimization purposes, since the base station 404 may for example no longer merely record trace files for TN cells 188 but may also record separate trace files for numerous, additional, NTN cells 189. Similar inefficiencies may arise on both the UE and network sides when MDT is applied to SONs or SBAs with multiple network functions or services associated with respective MDT data. Therefore, it would be helpful to enhance logged MDT configurations and reporting to better support mixed network deployments.

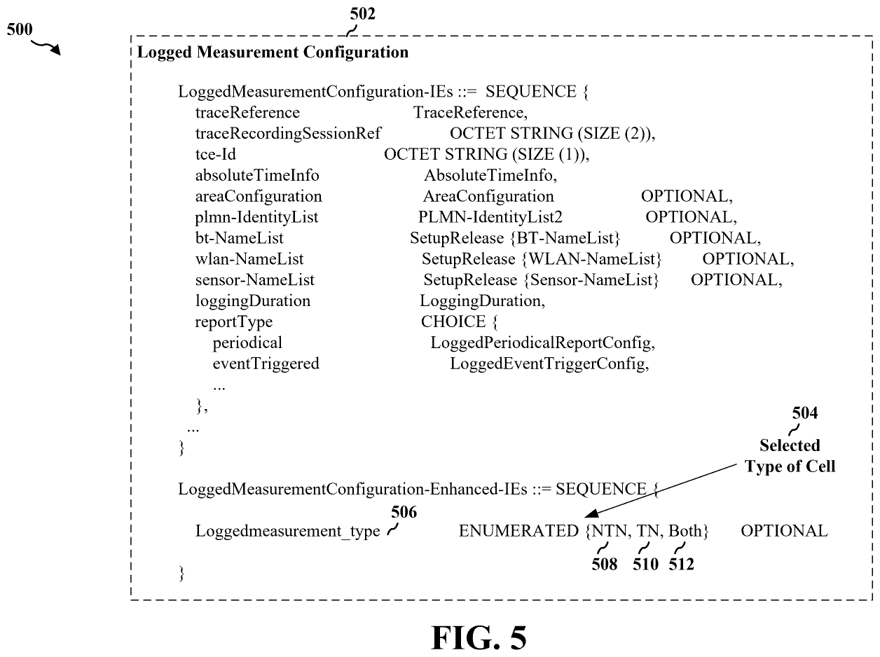

FIG. 5 illustrates an example 500 of an enhanced, logged measurement configuration 502 for MDT that better supports mixed network deployments including NTN cells and TN cells. Logged measurement configuration 502 may correspond to, and be an enhancement of, logged measurement configuration 408 in FIG. 4. In this example, in addition to including general MDT configuration parameters such as illustrated in FIG. 5, the logged measurement configuration 502 may include an additional parameter or information element which limits MDT measurement and reporting from the UE 402 to a selected type of cell 504 indicated in the configuration. In particular, the base station 404 may indicate a logged measurement type parameter 506 (or a logged measurement network type parameter or some other name) which indicates that either NTN cells 189, TN cells 188, or a combination of NTN cells 189 and TN cells 188 are selected for MDT measurement and reporting. If the logged measurement type parameter 506 selects an NTN cells only option 508, the UE 402 is configured to limit its MDT measurements to NTN cells 189 during the MDT session, while if the logged measurement type parameter 506 selects a TN cells only option 510, the UE 402 is configured to limit its MDT measurements to TN cells 188 during the MDT session. On the other hand, if the logged measurement type parameter 506 selects a combination of NTN cells and TN cells option 512, the UE 402 is not limited in its MDT measurements and may report measurement results for both NTN cells 189 and TN cells 188.

Thus, by including the logged measurement type parameter 506 which may be configurable to either NTN cells 189 or TN cells 188 in the logged measurement configuration 502 to satisfy current network interest, the base station 404 may configure the UE 402 to reduce or minimize the amount of its MDT measurements performed at block 414 in an MDT session. For example, in response to receiving the logged measurement type parameter 506, the UE 402 may determine which of the cells associated with MDT reporting, such as a list of cells in an area configuration or area scope parameter of the logged measurement configuration 502, correspond to the selected type of cells 504 indicated in the parameter (NTN cells, TN cells, or both NTN and TN cells), and during the MDT session, the UE 402 may perform MDT data collection at block 414 in the corresponding, selected type of cells 504 (one of options 508, 510, 512) while refraining from performing MDT measurements in the unselected types of cells (the remainder of options 508, 510, 512). As a result, the amount of segmented MDT reports sent to the base station 404 via UE information response messages 426, 432 may be efficiently reduced. For instance, if the selected type of cells 504 corresponds to the NTN cells only option 508, the UE 402 may provide an MDT report via UE information response messages 426, 432 for only NTN cells 189, while if the selected type of cells 504 corresponds to the TN cells only option 510, the UE 402 may provide an MDT report via UE information response messages 426, 432 for only TN cells 188. Such intelligent MDT reporting may result in the UE 402 experiencing less battery drainage or power consumption due to reduced MDT measurement scope. Additionally, since the parameter 506 may alternatively be configurable to both NTN cells and TN cells (via option 512), the base station 404 may still flexibly allow the UE 402 to measure both types of cells without reducing MDT measurement scope. In such case where the selected type of cells 504 corresponds to the combination of NTN cells and TN cells option 512, the UE 402 may provide at least one MDT report for NTN cells (for example via UE information response message 426) and at least one other MDT report for TN cells (for example via UE information response message 432).

As a result, the UE's MDT operations may be optimized for specific network operators or original equipment manufacturers that have interest in certain cell types (NTN, TN, or both). For example, if the core network 190 has more interest in NTN optimization than TN optimization, the base station 404 may configure the UE 402 via the logged measurement type parameter 506 to report MDT data specifically for NTN cells 189 via UE information response messages 426, 432, while if the core network 190 has more interest in TN optimization than NTN optimization, the base station 404 may configure the UE 402 via this parameter 506 instead to report MDT data specifically for TN cells 188 via UE information response messages 426, 432. Since the base station 404 may thus receive MDT data associated with either NTN cells 189 or TN cells 188, the base station 404 may more efficiently record this data in a separate trace file dedicated for the selected type of cell 504 for transport to the core network 190, since the base station 404 may not receive and therefore is not required to filter out MDT data associated with unselected types of cells. In the case where the core network 190 has interest in both NTN and TN optimization, the base station 404 may still configure the UE 402 via the logged measurement type parameter 506 to report MDT data for both NTN cells 189 and TN cells 188, and the base station 404 may continue to record and transport this data in separate trace files for NTN cells 189 and TN cells 188 to the core network 190.

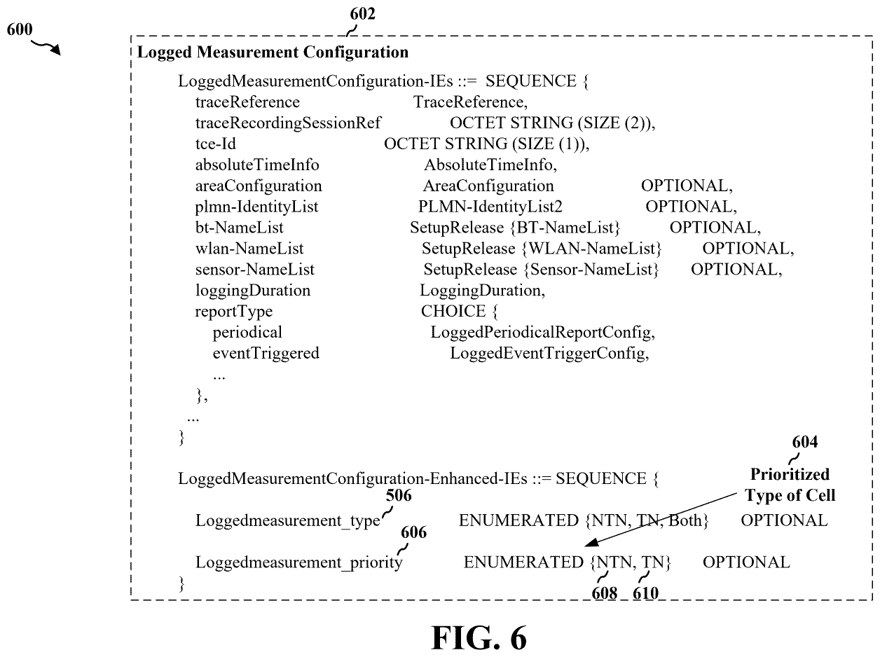

FIG. 6 illustrates another example 600 of an enhanced, logged measurement configuration 602 for MDT that better supports mixed network deployments including NTN cells and TN cells. Logged measurement configuration 602 may correspond to, and be an enhancement of, logged measurement configuration 408 in FIG. 4. In this example, in addition to including general MDT configuration parameters such as illustrated in FIGS. 5 and 6 and the logged measurement type parameter 506 described with respect to the example 500 of FIG. 5, here the logged measurement configuration 602 may further include an additional parameter or information element which prioritizes MDT measurement and reporting from the UE for a prioritized type of cell 604 indicated in the configuration. In particular, in addition to including the logged measurement type parameter 506 in the logged measurement configuration 602, the base station 404 may further indicate a logged measurement priority parameter 606 (or a logged measurement network priority parameter or some other name) which indicates that either NTN cells 189 or TN cells 188 are prioritized for MDT measurement and reporting. If the logged measurement priority parameter 606 selects an NTN cells option 608, the UE 402 is configured to prioritize its MDT measurements in NTN cells 189 during the MDT session, while if the logged measurement priority parameter 606 selects a TN cells option 610, the UE 402 is configured to prioritize its MDT measurements in TN cells 188 during the MDT session.

The logged measurement priority parameter 606 may be applicable in the specific case where the base station 404 configures the logged measurement type parameter 506 to indicate both NTN cells 189 and TN cells 188 are selected for MDT measurement and reporting. In such case where the UE 402 receives the logged measurement configuration 602 with the logged measurement type parameter 506 set to indicate both NTN and TN cells as the selected type of cells 504 (via option 512), and the logged measurement priority parameter 606 to indicate either NTN cells 189 or TN cells 188 as the prioritized type of cells 604 (via option 608 or option 610), the UE 402 may determine to follow either the configuration of the selected type of cells 504 or the configuration of the prioritized type of cells 604 when performing MDT measurements and sending MDT reports. Generally, this determination is based on UE state or capability. For example, if the UE 402 is in a state of having too low battery power, a state of high thermal activity, or another state subject to some other local parameter or factor which prevents or otherwise impacts the UE 402 from performing MDT data collection at block 414 in the complete set of NTN and TN cells within the time period of the MDT session, the UE 402 may determine to collect and report MDT measurement results for either NTN cells 189 or TN cells 188 (whichever is the indicated prioritized type of cells 604) but not both. Otherwise, if the UE 402 is not currently in such a limiting state, the UE 402 may proceed to collect and report MDT measurement results for NTN cells 189 and TN cells 188 as indicated in the selected type of cells 504. However, in other examples, prioritization of MDT measurement and reporting for the prioritized type of cells 604 indicated in the logged measurement priority parameter 606 may be performed without regard to whether the UE 402 is in a low power state, or otherwise may be performed independently of UE capability.

Thus, the logged measurement priority parameter 606 may support, but is not limited to, the case where there is a network interest in obtaining MDT reports for both NTN cells 189 and TN cells 188, but the UE 402 may have too limited capability to satisfy this network interest. For example, generally in cases where the UE 402 is unable to fully perform its MDT data collection of both NTN cells 189 and TN cells 188 due to a low power state or otherwise limited power capability, the UE 402 may end up stopping its MDT measurements midway through the complete set of cells, or avoid reporting a complete set of MDT measurements for its NTN cells 189 and TN cells 188, to compensate for the increased power consumption. Therefore, to minimize or prevent such MDT session shutdown from occurring when the UE 402 is in a low power state (or a power saving mode), the base station 404 in this example may configure the UE 402 to prioritize MDT measurement and reporting for either NTN cells 189 or TN cells 188 via the logged measurement priority parameter 606. Since the UE 402 is not required to measure and report MDT measurements for both NTN cells 189 and TN cells 188 when it prioritizes its reporting, the UE 402 may complete the MDT session even with low battery level, thereby optimizing the MDT measurement and reporting process. The UE 402 may also reduce its rate of power consumption as a result of prioritization. For example, if the UE 402 enters a low power state with 50% (or other quantity) battery capacity remaining, the UE 402 may switch from measuring and reporting MDT data in both NTN cells 189 and TN cells 188 without prioritization to measuring and reporting MDT data in only the prioritized type of cells 604, thereby draining its battery at a slower rate than the battery drain rate prior to the switch.

When the UE 402 prioritizes MDT measurement and reporting for a prioritized type of cell 604 such as NTN cells 189 or TN cells 188, the UE 402 may give preference to the prioritized cells for MDT measurement or reporting. For instance, when the UE 402 is in a low power state or otherwise, the UE 402 may determine the prioritized type of cells 604 is high priority and any remaining type of cells is low priority, and the UE 402 may flexibly reduce the measurement scope to the high priority cells or focus on preparing measurements for the high priority cells over low priority cells. For example, the UE 402 may collect or report MDT measurements specifically for the prioritized type of cells 604, the UE 402 may collect or report a larger quantity of MDT measurements for the prioritized type of cells 604 than for those of other types of cells, the UE 402 may collect or report measurements for the prioritized type of cells 604 ahead in time to those of other cells, the UE 402 may discard collected measurements for other cells in favor of the prioritized type of cells 604, or the UE may perform a combination of one or more of the foregoing operations. Additionally, when prioritizing a particular type of cells (such as NTN or TN), the UE 402 may select a quantity X of cells to include in its MDT report, where the value of X is dependent upon the UE's state or condition. For example, the UE 402 may send fewer MDT reports (a lower value of X or quantity of UE information response messages 426, 432) when the UE's battery level is lower or when the UE's measurement capability is poorer, but the UE may send more MDT reports (a higher value of X or quantity of UE information response messages 426, 432) when the UE's battery level is higher or when the UE's measurement capability is more moderate.

In one example of prioritization, the UE 402 may first report MDT measurements for high priority cells (such as via UE information response message 426) and subsequently report MDT measurements for low priority cells (such as via UE information response message 432). In another example of prioritization, the UE 402 may report MDT measurements for high priority cells more frequently than for low priority cells. In another example, the UE 402 may report MDT measurements for high priority cells in a shorter time duration while reporting MDT measurements for low priority cells in a longer time duration. In another example, the UE 402 may measure the high priority cells within the limited time of the MDT session first, and after completing measurements of these cells if there is still time remaining in the MDT session, the UE 402 may measure the low priority cells within the remaining time. In another example, when the UE 402 is segmenting its MDT reports, instead of sending reports according to a chronological order of cell identifier or in a FIFO order of stored measurement entries, the UE 402 may report the MDT results for high priority cells first and then the MDT results for low priority cells. In another example, if the UE 402 has limited memory capacity for stored MDT measurement entries, the UE 402 may measure or store MDT data for high priority cells in memory first, and if UE memory available for MDT data still remains, the UE 402 may then measure or store MDT data for low priority cells in the remaining available memory. In another example, if the UE 402 has limited memory capacity for MDT data, the UE 402 may overwrite previously stored MDT data associated with low priority cells in memory with MDT data measured in high priority cells, while refraining from overwriting previously stored MDT data associated with high priority cells with MDT data measured in low priority cells. The UE 402 may perform the foregoing actions or other actions, or a combination of any of the foregoing actions or other actions, when prioritizing MDT measurements for the prioritized type of cells 604.

While the aforementioned examples of FIGS. 5 and 6 specifically relate to mixed network deployments including NTN cells 189 and TN cells 188, these examples may similarly be extended to other mixed network deployments including SONs or SBAs. For instance, additionally or alternatively to indicating the UE 402 to perform MDT measurements for NTN cells 189, TN cells 188, or a combination of NTN cells 189 and TN cells 188, the logged measurement type parameter 506 may indicate (or limit) the UE 402 to perform MDT measurements and reporting for one or more different functions of a SON, one or more different network functions services in a SBA, or a combination of any one or more of the foregoing. Similarly, the logged measurement priority parameter 606 may indicate the UE 402 to prioritize MDT measurement and reporting for one or more different functions of a SON, one or more different services in an SBA, or a combination of any one or more of the foregoing. For example, in the logged measurement type parameter 506 and the logged measurement priority parameter 606 illustrated in the examples of FIGS. 5 and 6, the options 508, 510, 512, 608, 610 related to NTN cells 189 and TN cells 188 may be replaced with, or modified in combination with, SON-related options such as monitoring, analysis, decision, execution, evaluation, centralized SON, distributed SON, and the like, SBA-related options such as AMF, SMF, UPF, central cloud site, regional cloud site, edge cloud site, radio site, and the like. In response to determining whichever one or more of these or other SON functions, network functions, sites, processing capabilities, service capabilities, and the like are selected in the logged measurement type parameter 506 or logged measurement priority parameter 606, the UE 402 may perform MDT measurements and reporting in accordance with the selected option(s). Thus, the aspects of the present disclosure may not be limited to mixed network deployments including an NTN and a TN but may be extended to other mixed network deployments and similarly result in optimized or improved MDT coordination between the UE and network.

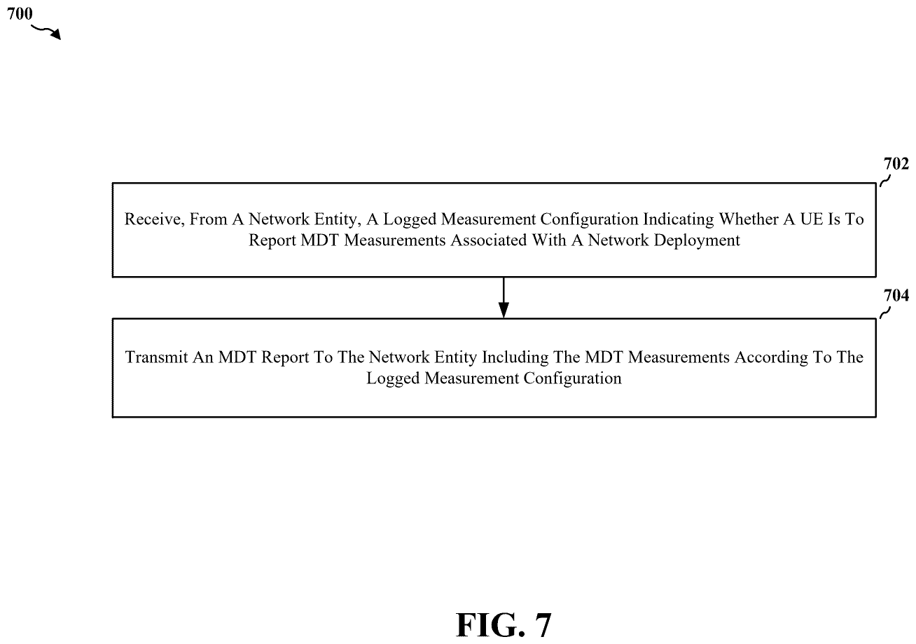

FIG. 7 is a flowchart 700 of an example method or process for wireless communication performable at a UE which performs optimized, MDT measurement and reporting in mixed network deployments. The method may be performed by a UE, such as the UE 104, 350, 402, the apparatus 902, or its components as described herein.

In some examples, in block 702, the UE receives, from a network entity, a logged measurement configuration indicating whether the UE is to report MDT measurements associated with a network deployment. For example, block 702 may be performed by logged measurement configuration component 940. In some examples, the network deployment is a network including NTN cells and TN cells. In some examples, the network deployment includes an SBA. In some examples, the network deployment includes a SON, and the MDT report is associated with the SON. For instance, referring to the Figures, UE 402 or logged measurement configuration component 940 may receive logged measurement configuration 502, 602 from base station 404 including logged measurement type parameter 506 or logged measurement priority parameter 606 which indicate to UE 402 whether to perform MDT data collection at block 414 during a logged MDT session in a selected type of cell 504 or a prioritized type of cell 604, such as in NTN cells 189 or in TN cells 188, in a network deployment such as the wireless communication system and access network 100 of FIG. 1A. For instance, the UE 402 may limit or prioritize its MDT data collection in NTN cells 189 or in TN cells 188 depending on the values of the parameters indicated in the logged measurement configuration 502, 602. Alternatively or additionally, the logged measurement configuration 502 may include same or similar parameters which indicate to UE 402 whether to perform the MDT data collection for a selected type or prioritized type of SON function (such as for monitoring, analysis, decision, execution, evaluation, or the like), SON deployment (such as a centralized SON, distributed SON, and the like), network function (such as the AMF 192, SMF 194, UPF 195, or the like), SBA software-defined service or site (such as a cloud native environment or central cloud site, regional cloud site, edge cloud site, radio site, or the like), network operator, or for other purposes. The collected MDT data may include MDT measurements such as, but not limited to, DL signal quantities measurement results for a serving cell and for intra-frequency/inter-frequency/inter-RAT neighbor cells, power headroom measurements, PDCP SDU data volume measurements separately for DL and UL, average UE throughput measurements separately for DL and UL, packet delay measurements, packet loss rate measurements, received signal strength indicator (RSSI) measurements for WLAN and Bluetooth®, round trip time (RTT) measurement for WLAN, or any combination of the foregoing.

In some examples, in block 704, the UE transmits an MDT report to the network entity including the MDT measurements according to the logged measurement configuration. For example, block 704 may be performed by MDT report component 942. For instance, referring to the Figures, UE 402 or MDT report component 942 may transmit UE information response message(s) 426, 432 to base station 404 including a report of the MDT data collected at block 414. The MDT measurements may be collected, or the UE information response message(s) 426, 432 may be reported, according to the logged measurement configuration 502, 602 received from base station 404. For example, if the logged measurement configuration 502, 602 indicates the UE to limit its MDT measurements to NTN cells 189 (via the logged measurement type parameter 506), the UE may limit collection and transmission of MDT data in the UE information response message(s) 426, 432 to the selected type of cell 504 (in this example including NTN cells 189) but not including the remaining unselected type of cells (in this example excluding TN cells 188). Alternatively, if the logged measurement configuration 502, 602 indicates the UE may perform MDT measurements in both NTN cells 189 and TN cells 188 (via the logged measurement type parameter 506) but that the UE is to specifically prioritize its MDT measurement and reporting for TN cells 188 (via the logged measurement priority parameter 606), the UE may preferentially collect or transmit MDT data in the UE information response message(s) 426, 432 for the prioritized type of cell 604 (in this example the TN cells 188), while giving less (or no) priority to the remaining unprioritized type of cell (in this example NTN cells 189).

In some examples, the logged measurement configuration (received at block 702) indicates the UE to report the MDT measurements for a selected type of cells associated with the network deployment. In some examples, the selected type of cells for the MDT measurements is one of: the NTN cells, the TN cells, or the NTN cells and the TN cells. For instance, referring to the Figures, logged measurement configuration 502, 602 may include logged measurement type parameter 506 which indicates the selected type of cell 504 in the wireless communication system and access network 100 in which the UE 402 is to collect MDT data at block 414 and report the MDT data in UE information response message(s) 426, 432. The selected type of cell 504 may be, for example, NTN cells 189 (via selection of NTN cells only option 508), TN cells 188 (via selection of TN cells only option 510), or both NTN cells 189 and TN cells 188 (via selection of the combination of NTN cells and TN cells option 512).

In some examples, the selected type of cells for the MDT measurements includes NTN cells and TN cells, the MDT report (transmitted at block 704) includes the MDT measurements for only the TN cells, and the UE transmits another MDT report to the network entity including the MDT measurements for only the NTN cells. For instance, referring to the Figures, when both NTN cells 189 and TN cells 188 are configured for the selected type of cell 504 (via selection of the combination of NTN cells and TN cells option 512 in the logged measurement type parameter 506), the UE 402 may transmit UE information response message 426 specifically reporting the MDT data collected in TN cells 188, and the UE 402 may subsequently transmit UE information response message 432 specifically reporting the MDT data collected in NTN cells 189. Thus, the UE may separate MDT data collected in different types of cells respectively into different MDT reports or UE information response messages. If the total UE log for NTN cells and the total UE log for TN cells exceeds an RRC segmentation threshold (for example 8 KB or other predetermined size per MDT report), the UE may similarly transmit multiple UE information response messages separately including respective segments of MDT data for NTN cells 189 and TN cells 188. Thus, a single MDT report may not include MDT data for both NTN cells 189 and TN cells 188, even if both cells are selected in the logged measurement type parameter 506.

In some examples, the logged measurement configuration (received at block 702) indicates the UE to optionally report the MDT measurements for a prioritized type of cells associated with the network deployment. In some examples, the prioritized type of cells for the MDT measurements is one of: the NTN cells, or the TN cells. For instance, referring to the Figures, logged measurement configuration 602 may include logged measurement priority parameter 606 which indicates the prioritized type of cells 604 in the wireless communication system and access network 100 in which the UE 402 is to prioritize MDT data collection at block 414 or MDT data reporting in UE information response message(s) 426, 432. The prioritized type of cells 604 may be, for example, NTN cells 189 (via selection of NTN cells option 608), or TN cells 188 (via selection of TN cells option 610). Prioritization of MDT data collection or MDT data reporting based on the logged measurement priority parameter 606 may be optional; for example, the UE 402 may determine to follow either the configuration of the selected type of cells 504 or the configuration of the prioritized type of cells 604 when performing MDT measurements and sending MDT report depending on a current UE state or capability.

In some examples, the logged measurement configuration (received at block 702) further indicates a selected type of cells for the MDT measurements including NTN cells and TN cells, and the MDT report (transmitted at block 704) prioritizes the MDT measurements for the prioritized type of cells in response to a state of the UE. For instance, referring to the Figures, if the logged measurement type parameter 506 indicates the selected type of cells 504 includes both NTN cells 189 and TN cells 188 (via option 512), then the UE 402 may prioritize MDT collection at block 414 and transmission of collected MDT data in UE information response message(s) 426, 432 for the prioritized type of cells 604 indicated in the logged measurement priority parameter 606. Prioritization may be based on a current UE state or capability. For example, if the UE 402 is in a state of having too low battery power, a state of high thermal activity, or another state subject to some other local parameter or factor which prevents or otherwise impacts the UE 402 from performing MDT data collection at block 414 in the complete set of NTN and TN cells within the time period of the MDT session, the UE 402 may determine to prioritize MDT reporting of measurement results for either NTN cells 189 or TN cells 188 (whichever is the indicated prioritized type of cells 604). When the MDT report prioritizes MDT measurements for a prioritized type of cell 604 such as NTN cells 189 or TN cells 188, preference may be given to the prioritized cells. For instance, when the UE 402 is in a low power state or otherwise, the UE 402 may determine the prioritized type of cells 604 is high priority and any remaining type of cells is low priority, and the UE 402 may flexibly reduce the measurement scope to the high priority cells or focus on preparing measurements for the high priority cells over low priority cells.

In some examples, the MDT report (transmitted at block 704) includes the MDT measurements for one or more cells of the prioritized type of cells, and a quantity of the one or more cells is responsive to the state of the UE. For instance, referring to the Figures, when prioritizing a particular type of cells (such as NTN cells 189 or TN cells 188) according to the logged measurement priority parameter 606, the UE 402 may select a quantity X of these cells to include in its MDT report, where the value of X is dependent upon the UE's state or condition. For example, the UE 402 may send fewer MDT reports (a lower value of X or quantity of UE information response messages 426, 432) when the UE's battery level is lower or when the UE's measurement capability is poorer, but the UE may send more MDT reports (a higher value of X or quantity of UE information response messages 426, 432) when the UE's battery level is higher or when the UE's measurement capability is more moderate.

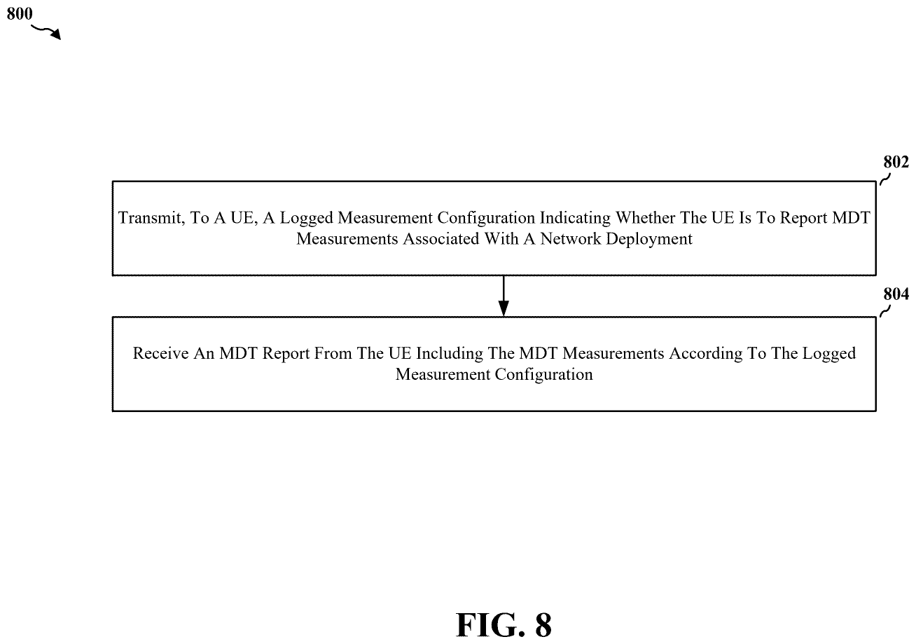

FIG. 8 is a flowchart 800 of an example method or process for wireless communication performable at a network entity which configures a UE to perform optimized, MDT measurement and reporting in mixed network deployments. The method may be performed by a network entity, such as the base station 102/180, 181, 310, 404, the apparatus 1002, or its components as described herein.

In some examples, at block 802, the network entity transmits, to a UE, a logged measurement configuration indicating whether the UE is to report MDT measurements associated with a network deployment. For example, block 802 may be performed by logged measurement configuration component 1040. In some examples, the network deployment is a network including NTN cells and TN cells. In some examples, the network deployment includes an SBA or a SON associated with the MDT report. For instance, referring to the Figures, base station 404 or logged measurement configuration component 1040 may transmit logged measurement configuration 502, 602 to UE 402 including logged measurement type parameter 506 or logged measurement priority parameter 606 which indicate to UE 402 whether to perform MDT data collection at block 414 during a logged MDT session in a selected type of cell 504 or a prioritized type of cell 604, such as in NTN cells 189 or in TN cells 188, in a network deployment such as the wireless communication system and access network 100 of FIG. 1A. For instance, the base station 404 may configure the UE 402 to limit or prioritize its MDT data collection in NTN cells 189 or in TN cells 188 depending on the values of the parameters indicated in the logged measurement configuration 502, 602. Alternatively or additionally, the logged measurement configuration 502 may include same or similar parameters which indicate to UE 402 whether to perform the MDT data collection for a selected type or prioritized type of SON function (such as for monitoring, analysis, decision, execution, evaluation, or the like), SON deployment (such as a centralized SON, distributed SON, and the like), network function (such as the AMF 192, SMF 194, UPF 195, or the like), SBA software-defined service or site (such as a cloud native environment or central cloud site, regional cloud site, edge cloud site, radio site, or the like), network operator, or for other purposes. The collected MDT data may include MDT measurements such as, but not limited to, DL signal quantities measurement results for a serving cell and for intra-frequency/inter-frequency/inter-RAT neighbor cells, power headroom measurements, PDCP SDU data volume measurements separately for DL and UL, average UE throughput measurements separately for DL and UL, packet delay measurements, packet loss rate measurements, received signal strength indicator (RSSI) measurements for WLAN and Bluetooth®, round trip time (RTT) measurement for WLAN, or any combination of the foregoing.

In some examples, in block 804, the network entity receives an MDT report from the UE including the MDT measurements according to the logged measurement configuration. For example, block 804 may be performed by MDT report component 1042. For instance, referring to the Figures, base station 404 or MDT report component 1042 may receive UE information response message(s) 426, 432 from UE 402 including a report of the MDT data collected at block 414. The MDT measurements may be collected, or the UE information response message(s) 426, 432 may be reported, according to the logged measurement configuration 502, 602 received from base station 404. For example, if the logged measurement configuration 502, 602 indicates the UE to limit its MDT measurements to NTN cells 189 (via the logged measurement type parameter 506), the UE may limit collection and transmission of MDT data in the UE information response message(s) 426, 432 to the selected type of cell 504 (in this example including NTN cells 189) but not including the remaining unselected type of cells (in this example excluding TN cells 188). Alternatively, if the logged measurement configuration 502, 602 indicates the UE may perform MDT measurements in both NTN cells 189 and TN cells 188 (via the logged measurement type parameter 506) but that the UE is to specifically prioritize its MDT measurement and reporting for TN cells 188 (via the logged measurement priority parameter 606), the UE may preferentially collect or transmit MDT data in the UE information response message(s) 426, 432 for the prioritized type of cell 604 (in this example the TN cells 188), while giving less (or no) priority to the remaining unprioritized type of cell (in this example NTN cells 189).

In some examples, the logged measurement configuration (transmitted at block 802) indicates the UE to report the MDT measurements for a selected type of cells associated with the network deployment. In some examples, the selected type of cells for the MDT measurements is one of: the NTN cells, the TN cells, or the NTN cells and the TN cells. For instance, referring to the Figures, logged measurement configuration 502, 602 may include logged measurement type parameter 506 which indicates the selected type of cell 504 in the wireless communication system and access network 100 in which the UE 402 is to collect MDT data at block 414 and report the MDT data in UE information response message(s) 426, 432 to base station 404. The selected type of cell 504 may be, for example, NTN cells 189 (via selection of NTN cells only option 508), TN cells 188 (via selection of TN cells only option 510), or both NTN cells 189 and TN cells 188 (via selection of the combination of NTN cells and TN cells option 512).

In some examples, the selected type of cells for the MDT measurements includes NTN cells and TN cells, the MDT report (received at block 804) includes the MDT measurements for only the TN cells, and the network entity receives another MDT report from the UE including the MDT measurements for only the NTN cells. For instance, referring to the Figures, when both NTN cells 189 and TN cells 188 are configured for the selected type of cell 504 (via selection of the combination of NTN cells and TN cells option 512 in the logged measurement type parameter 506), the base station 404 may receive UE information response message 426 from UE 402 specifically reporting the MDT data collected in TN cells 188, and the base station 404 may subsequently receive UE information response message 432 from UE 402 specifically reporting the MDT data collected in NTN cells 189. Thus, the UE may separate MDT data collected in different types of cells respectively into different MDT reports or UE information response messages. If the total UE log for NTN cells and the total UE log for TN cells exceeds an RRC segmentation threshold (for example 8 KB or other predetermined size per MDT report), the base station may similarly receive multiple UE information response messages separately including respective segments of MDT data for NTN cells 189 and TN cells 188. Thus, a single MDT report may not include MDT data for both NTN cells 189 and TN cells 188, even if both cells are selected in the logged measurement type parameter 506.

In some examples, the logged measurement configuration (transmitted at block 802) indicates the UE to optionally report the MDT measurements for a prioritized type of cells associated with the network deployment. In some examples, the prioritized type of cells for the MDT measurements is one of: the NTN cells, or the TN cells. For instance, referring to the Figures, logged measurement configuration 602 may include logged measurement priority parameter 606 which indicates the prioritized type of cells 604 in the wireless communication system and access network 100 in which the UE 402 is to prioritize MDT data collection at block 414 or MDT data reporting in UE information response message(s) 426, 432. The prioritized type of cells 604 may be, for example, NTN cells 189 (via selection of NTN cells option 608), or TN cells 188 (via selection of TN cells option 610). Prioritization of MDT data collection or MDT data reporting based on the logged measurement priority parameter 606 may be optional; for example, the UE 402 may determine to follow either the configuration of the selected type of cells 504 or the configuration of the prioritized type of cells 604 when performing MDT measurements and sending MDT report depending on a current UE state or capability.

In some examples, the logged measurement configuration (transmitted at block 802) further indicates a selected type of cells for the MDT measurements including NTN cells and TN cells, and the MDT report (received at block 804) prioritizes the MDT measurements for the prioritized type of cells in response to a state of the UE. For instance, referring to the Figures, if the logged measurement type parameter 506 indicates the selected type of cells 504 includes both NTN cells 189 and TN cells 188 (via option 512), then the base station 404 may configure the UE 402 to prioritize MDT collection at block 414 and transmission of collected MDT data in UE information response message(s) 426, 432 for the prioritized type of cells 604 indicated in the logged measurement priority parameter 606. Prioritization may be based on a current UE state or capability. For example, if the UE 402 is in a state of having too low battery power, a state of high thermal activity, or another state subject to some other local parameter or factor which prevents or otherwise impacts the UE 402 from performing MDT data collection at block 414 in the complete set of NTN and TN cells within the time period of the MDT session, the UE 402 may determine to prioritize MDT reporting of measurement results for either NTN cells 189 or TN cells 188 (whichever is the indicated prioritized type of cells 604). When the MDT report prioritizes MDT measurements for a prioritized type of cell 604 such as NTN cells 189 or TN cells 188, preference may be given to the prioritized cells. For instance, when the UE 402 is in a low power state or otherwise, the UE 402 may determine the prioritized type of cells 604 is high priority and any remaining type of cells is low priority, and the UE 402 may flexibly reduce the measurement scope to the high priority cells or focus on preparing measurements for the high priority cells over low priority cells.

In some examples, the MDT report (received at block 804) includes the MDT measurements for one or more cells of the prioritized type of cells, and a quantity of the one or more cells is responsive to the state of the UE. For instance, referring to the Figures, when prioritizing a particular type of cells (such as NTN cells 189 or TN cells 188) according to the logged measurement priority parameter 606, the UE 402 may select a quantity X of these cells to include in its MDT report, where the value of X is dependent upon the UE's state or condition. For example, the base station 404 may receive fewer MDT reports (a lower value of X or quantity of UE information response messages 426, 432) when the UE's battery level is lower or when the UE's measurement capability is poorer, but the base station 404 may receive more MDT reports (a higher value of X or quantity of UE information response messages 426, 432) when the UE's battery level is higher or when the UE's measurement capability is more moderate.

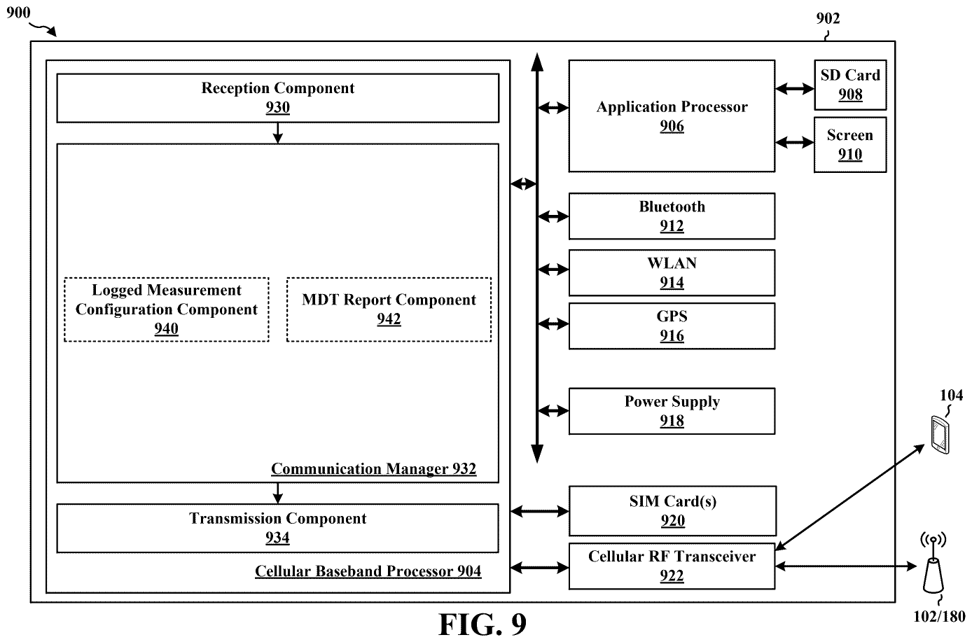

FIG. 9 is a diagram 900 illustrating an example of a hardware implementation for an apparatus 902 that supports optimized, MDT measurement and reporting in mixed network deployments according to some aspects of the present disclosure. The apparatus 902 is a UE and includes a cellular baseband processor 904 (also referred to as a modem) coupled to a cellular RF transceiver 922 and one or more subscriber identity modules (SIM) cards 920, an application processor 906 coupled to a secure digital (SD) card 908 and a screen 910, a Bluetooth module 912, a wireless local area network (WLAN) module 914, a Global Positioning System (GPS) module 916, and a power supply 918. The cellular baseband processor 904 communicates through the cellular RF transceiver 922 with the UE 104 and/or BS 102/180. The cellular baseband processor 904 may include a computer-readable medium/memory. The computer-readable medium/memory may be non-transitory. The cellular baseband processor 904 is responsible for general processing, including the execution of software stored on the computer-readable medium/memory. The software, when executed by the cellular baseband processor 904, causes the cellular baseband processor 904 to perform the various functions described supra. The computer-readable medium/memory may also be used for storing data that is manipulated by the cellular baseband processor 904 when executing software. The cellular baseband processor 904 further includes a reception component 930, a communication manager 932, and a transmission component 934. The communication manager 932 includes the one or more illustrated components. The components within the communication manager 932 may be stored in the computer-readable medium/memory and/or configured as hardware within the cellular baseband processor 904. The cellular baseband processor 904 may be a component of the UE 104, 350, 402 and may include the memory 360 and/or at least one of the TX processor 368, the RX processor 356, and the controller/processor 359. In one configuration, the apparatus 902 may be a modem chip and include just the baseband processor 904, and in another configuration, the apparatus 902 may be the entire UE (e.g., see UE 350 of FIG. 3) and include the aforediscussed additional modules of the apparatus 902.

The communication manager 932 includes a logged measurement configuration component 940 that is configured to receive via reception component 930, from a network entity, a logged measurement configuration indicating whether the apparatus is to report MDT measurements associated with a network deployment, such as described in connection with block 702 of FIG. 7. The reception component 930 may be configured to receive, demodulate and decode the logged measurement configuration from the network entity and provide the demodulated and decoded logged measurement configuration to the logged measurement configuration component 940, where the reception, demodulation and decoding may be performed such as described in connection with FIG. 3. The communication manager 932 further includes an MDT report component 942 that is configured to transmit via transmission component 934 an MDT report to the network entity including the MDT measurements according to the logged measurement configuration, such as described in connection with block 704 of FIG. 7. The transmission component 934 may be configured to obtain the MDT report from the MDT report component 942 and encode, modulate, and transmit the MDT report to the network entity, where the coding, modulation, and transmission may be performed such as described in connection with FIG. 3.

The apparatus may include additional components that perform each of the blocks of the algorithm in the aforementioned flowchart of FIG. 7. As such, each block in the aforementioned flowchart of FIG. 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 902, and in particular the cellular baseband processor 904, includes means for receiving, from a network entity, a logged measurement configuration indicating whether the apparatus is to report MDT measurements associated with a network deployment, and means for transmitting an MDT report to the network entity including the MDT measurements according to the logged measurement configuration.

The aforementioned means may be one or more of the aforementioned components of the apparatus 902 configured to perform the functions recited by the aforementioned means. As described supra, the apparatus 902 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

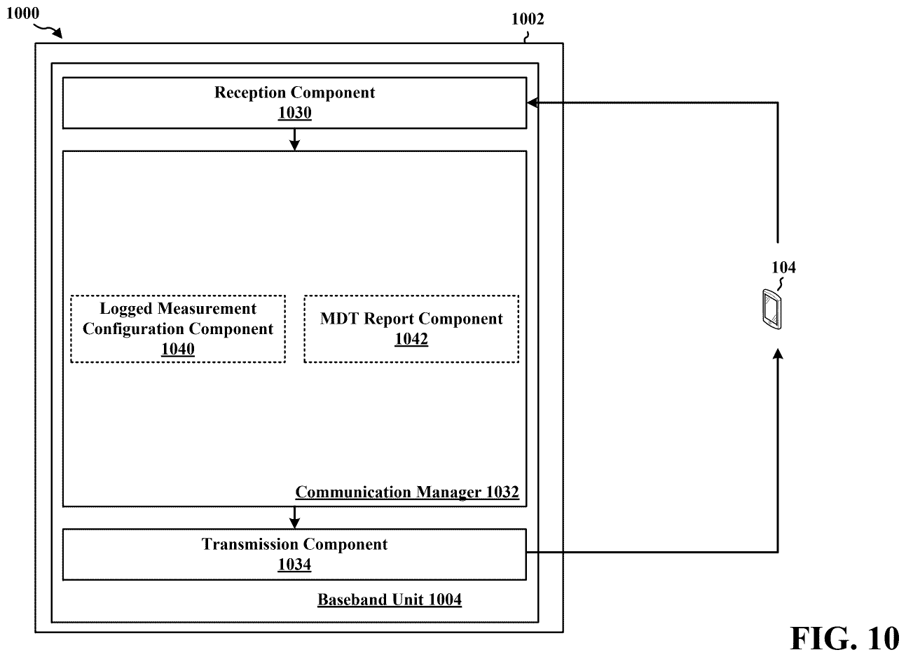

FIG. 10 is a diagram 1000 illustrating an example of a hardware implementation for an apparatus 1002 that supports optimized, MDT measurement and reporting in mixed network deployments according to some aspects of the present disclosure. The apparatus 1002 is a base station (BS) and includes a baseband unit 1004. The baseband unit 1004 may communicate through a cellular RF transceiver with the UE 104. The baseband unit 1004 may include a computer-readable medium/memory. The baseband unit 1004 is responsible for general processing, including the execution of software stored on the computer-readable medium/memory. The software, when executed by the baseband unit 1004, causes the baseband unit 1004 to perform the various functions described supra. The computer-readable medium/memory may also be used for storing data that is manipulated by the baseband unit 1004 when executing software. The baseband unit 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the baseband unit 1004. The baseband unit 1004 may be a component of the BS 102/180, 181, 310, 404 and may include the memory 376 and/or at least one of the TX processor 316, the RX processor 370, and the controller/processor 375.

The communication manager 1032 includes a logged measurement configuration component 1040 that is configured to transmit via transmission component 1034, to a UE, a logged measurement configuration indicating whether the UE is to report MDT measurements associated with a network deployment, such as described with respect to block 802 of FIG. 8. The transmission component 934 may be configured to obtain the logged measurement configuration from the logged measurement configuration component 1040 and encode, modulate, and transmit the logged measurement configuration to the UE, where the coding, modulation, and transmission may be performed such as described in connection with FIG. 3. The communication manager 1032 further includes an MDT report component 1042 that is configured to receive via reception component 1030 an MDT report from the UE including the MDT measurements according to the logged measurement configuration, such as described with respect to block 804 of FIG. 8. The reception component 930 may be configured to receive, demodulate and decode the MDT report from the UE and provide the demodulated and decoded MDT report to the MDT report component 1042, where the reception, demodulation and decoding may be performed such as described in connection with FIG. 3.

The apparatus may include additional components that perform each of the blocks of the algorithm in the aforementioned flowchart of FIG. 8. As such, each block in the aforementioned flowchart of FIG. 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the baseband unit 1004, includes means for transmitting, to a UE, a logged measurement configuration indicating whether the UE is to report MDT measurements associated with a network deployment, and means for receiving an MDT report from the UE including the MDT measurements according to the logged measurement configuration.

The aforementioned means may be one or more of the aforementioned components of the apparatus 1002 configured to perform the functions recited by the aforementioned means. As described supra, the apparatus 1002 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Clause 1. A method for wireless communication performable at a UE, comprising: receiving, from a network entity, a logged measurement configuration indicating whether the UE is to report MDT measurements associated with a network deployment; and transmitting an MDT report to the network entity including the MDT measurements according to the logged measurement configuration.

Clause 2. The method of clause 1, wherein the network deployment includes an SBA.

Clause 3. The method of clause 1 or clause 2, wherein the network deployment includes a SON, and the MDT report is associated with the SON.

Clause 4. The method of any of clauses 1 to 3, wherein the logged measurement configuration indicates the UE to report the MDT measurements for a selected type of cells associated with the network deployment.

Clause 5. The method of clause 4, wherein the network deployment is a network including NTN cells and TN cells, and the selected type of cells for the MDT measurements is one of: the NTN cells, the TN cells, or the NTN cells and the TN cells.

Clause 6. The method of clause 4 or clause 5, further comprising: wherein the selected type of cells for the MDT measurements includes NTN cells and TN cells, wherein the MDT report includes the MDT measurements for only the TN cells, and transmitting another MDT report to the network entity including the MDT measurements for only the NTN cells.

Clause 7. The method of any of clauses 1 to 6, wherein the logged measurement configuration indicates the UE to optionally report the MDT measurements for a prioritized type of cells associated with the network deployment.

Clause 8. The method of clause 7, wherein the network deployment is a network including NTN cells and TN cells, and the prioritized type of cells for the MDT measurements is one of: the NTN cells, or the TN cells.

Clause 9. The method of clause 7 or clause 8, wherein the logged measurement configuration further indicates a selected type of cells for the MDT measurements including NTN cells and TN cells, and wherein the MDT report prioritizes the MDT measurements for the prioritized type of cells in response to a state of the UE.

Clause 10. The method of clause 9, wherein the MDT report includes the MDT measurements for one or more cells of the prioritized type of cells, a quantity of the one or more cells being responsive to the state of the UE.

Clause 11. An apparatus for wireless communication, comprising: a memory; and a processor communicatively coupled with the memory, the processor operable to cause the apparatus to: receive, from a network entity, a logged measurement configuration indicating whether the apparatus is to report MDT measurements associated with a network deployment; and transmit an MDT report to the network entity including the MDT measurements according to the logged measurement configuration.

Clause 12. The apparatus of clause 11, wherein the logged measurement configuration indicates the apparatus to report the MDT measurements for a selected type of cells associated with the network deployment.

Clause 13. The apparatus of clause 12, wherein the network deployment is a network including NTN cells and TN cells, and the selected type of cells for the MDT measurements is one of: the NTN cells, the TN cells, or the NTN cells and the TN cells.

Clause 14. The apparatus of any of clauses 11 to 13, wherein the logged measurement configuration indicates the apparatus to optionally report the MDT measurements for a prioritized type of cells associated with the network deployment.

Clause 15. The apparatus of clause 14, wherein the network deployment is a network including NTN cells and TN cells, and the prioritized type of cells for the MDT measurements is one of: the NTN cells, or the TN cells.

Clause 16. The apparatus of clause 14 or clause 15, wherein the logged measurement configuration further indicates a selected type of cells for the MDT measurements including NTN cells and TN cells, and wherein the MDT report prioritizes the MDT measurements for the prioritized type of cells in response to a state of the apparatus.

Clause 17. The apparatus of clause 16, wherein the MDT report includes the MDT measurements for one or more cells of the prioritized type of cells, a quantity of the one or more cells being responsive to the state of the apparatus.

Clause 18. A method for wireless communication performable at a network entity, comprising: transmitting, to a UE, a logged measurement configuration indicating whether the UE is to report MDT measurements associated with a network deployment; and receiving an MDT report from the UE including the MDT measurements according to the logged measurement configuration.

Clause 19. The method of clause 18, wherein the logged measurement configuration indicates the UE to report the MDT measurements for a selected type of cells associated with the network deployment.

Clause 20. The method of clause 19, wherein the network deployment is a network including NTN cells and TN cells, and the selected type of cells for the MDT measurements is one of: the NTN cells, the TN cells, or the NTN cells and the TN cells.

Clause 21. The method of clause 19 or clause 20, further comprising: wherein the selected type of cells for the MDT measurements includes NTN cells and TN cells, wherein the MDT report includes the MDT measurements for only the TN cells, and receiving another MDT report from the UE including the MDT measurements for only the NTN cells.

Clause 22. The method of any of clauses 18 to 21, wherein the logged measurement configuration indicates the UE to optionally report the MDT measurements for a prioritized type of cells associated with the network deployment.

Clause 23. The method of clause 22, wherein the network deployment is a network including NTN cells and TN cells, and the prioritized type of cells for the MDT measurements is one of: the NTN cells, or the TN cells.

Clause 24. The method of clause 22 or clause 23, wherein the logged measurement configuration further indicates a selected type of cells for the MDT measurements including NTN cells and TN cells, and wherein the MDT report prioritizes the MDT measurements for the prioritized type of cells in response to a state of the UE.

Clause 25. The method of clause 24, wherein the MDT report includes the MDT measurements for one or more cells of the prioritized type of cells, a quantity of the one or more cells being responsive to the state of the UE.

Clause 26. An apparatus for wireless communication, comprising: a memory; and a processor communicatively coupled with the memory, the processor operable to cause the apparatus to: transmit, to a UE, a logged measurement configuration indicating whether the UE is to report MDT measurements associated with a network deployment; and receive an MDT report from the UE including the MDT measurements according to the logged measurement configuration.

Clause 27. The apparatus of clause 26, wherein the network deployment includes an SBA or an SON associated with the MDT report.

Clause 28. The apparatus of clause 26 or clause 27, wherein the logged measurement configuration indicates the UE to report the MDT measurements for a selected type of cells associated with the network deployment.

Clause 29. The apparatus of any of clauses 26 to 28, wherein the logged measurement configuration indicates the UE to optionally report the MDT measurements for a prioritized type of cells associated with the network deployment.

Clause 30. The apparatus of clause 29, wherein the logged measurement configuration further indicates a selected type of cells for the MDT measurements including NTN cells and TN cells, and wherein the MDT report prioritizes the MDT measurements for the prioritized type of cells in response to a state of the UE.

1. A method for wireless communication performable at a user equipment (UE), comprising:
receiving, from a network entity, a logged measurement configuration indicating whether the UE is to report minimization of drive test (MDT) measurements associated with a network deployment; and
transmitting an MDT report to the network entity including the MDT measurements according to the logged measurement configuration.

2. The method of claim 1, wherein the network deployment includes a service-based architecture (SB A).

3. The method of claim 1, wherein the network deployment includes a self organizing network (SON), and the MDT report is associated with the SON.

4. The method of claim 1, wherein the logged measurement configuration indicates the UE to report the MDT measurements for a selected type of cells associated with the network deployment.

5. The method of claim 4, wherein the network deployment is a network including non-terrestrial network (NTN) cells and terrestrial network (TN) cells, and the selected type of cells for the MDT measurements is one of:
the NTN cells,
the TN cells, or
the NTN cells and the TN cells.

6. The method of claim 4, further comprising:
wherein the selected type of cells for the MDT measurements includes non-terrestrial network (NTN) cells and terrestrial network (TN) cells,
wherein the MIDT report includes the MDT measurements for only the TN cells,
transmitting another MDT report to the network entity including the MDT measurements for only the NTN cells.

7. The method of claim 1, wherein the logged measurement configuration indicates the UE to optionally report the MDT measurements for a prioritized type of cells associated with the network deployment.

8. The method of claim 7, wherein the network deployment is a network including non-terrestrial network (NTN) cells and terrestrial network (TN) cells, and the prioritized type of cells for the MDT measurements is one of:
the NTN cells, or
the TN cells.

9. The method of claim 7,
wherein the logged measurement configuration further indicates a selected type of cells for the MDT measurements including non-terrestrial network (NTN) cells and terrestrial network (TN) cells, and
wherein the MIDT report prioritizes the MDT measurements for the prioritized type of cells in response to a state of the UE.

10. The method of claim 9, wherein the MDT report includes the MDT measurements for one or more cells of the prioritized type of cells, a quantity of the one or more cells being responsive to the state of the UE.

11. An apparatus for wireless communication, comprising:
a memory; and
a processor communicatively coupled with the memory, the processor operable to cause the apparatus to:
receive, from a network entity, a logged measurement configuration indicating whether the apparatus is to report minimization of drive test (MDT) measurements associated with a network deployment; and
transmit an MDT report to the network entity including the MDT measurements according to the logged measurement configuration.

12. The apparatus of claim 11, wherein the logged measurement configuration indicates the apparatus to report the MDT measurements for a selected type of cells associated with the network deployment.

13. The apparatus of claim 12, wherein the network deployment is a network including non-terrestrial network (NTN) cells and terrestrial network (TN) cells, and the selected type of cells for the MDT measurements is one of:
the NTN cells,
the TN cells, or
the NTN cells and the TN cells.

14. The apparatus of claim 11, wherein the logged measurement configuration indicates the apparatus to optionally report the MDT measurements for a prioritized type of cells associated with the network deployment.

15. The apparatus of claim 14, wherein the network deployment is a network including non-terrestrial network (NTN) cells and terrestrial network (TN) cells, and the prioritized type of cells for the MDT measurements is one of:
the NTN cells, or
the TN cells.

16. The apparatus of claim 14,
wherein the logged measurement configuration further indicates a selected type of cells for the MDT measurements including non-terrestrial network (NTN) cells and terrestrial network (TN) cells, and
wherein the MDT report prioritizes the MDT measurements for the prioritized type of cells in response to a state of the apparatus.

17. The apparatus of claim 16, wherein the MDT report includes the MDT measurements for one or more cells of the prioritized type of cells, a quantity of the one or more cells being responsive to the state of the apparatus.

18-25. (canceled)

26. An apparatus for wireless communication, comprising:
a memory; and
a processor communicatively coupled with the memory, the processor operable to cause the apparatus to:
transmit, to a user equipment (UE), a logged measurement configuration indicating whether the UE is to report minimization of drive test (MDT) measurements associated with a network deployment; and
receive an MDT report from the UE including the MDT measurements according to the logged measurement configuration.

27. The apparatus of claim 26, wherein the network deployment includes a service-based architecture (SBA) or a self-organizing network (SON) associated with the MDT report.

28. The apparatus of claim 26, wherein the logged measurement configuration indicates the UE to report the MDT measurements for a selected type of cells associated with the network deployment.

29-30. (canceled)
